(19) United States
(12) Patent Application Publication
(10) Pub. No.: US 2022/0250705 A1
(43) Pub. Date: Aug. 11, 2022

(54) ALL-TERRAIN VEHICLE

(71) Applicant: SEGWAY TECHNOLOGY CO., LTD., Changzhou (CN)

(72) Inventor: Zhen DONG, Changzhou (CN)

(21) Appl. No.: 17/667,598

(22) Filed: Feb. 9, 2022

(30) Foreign Application Priority Data
Feb. 10, 2021 (CN) 202120374068.1

(51) Int. Cl. B62K 5/01; B62K 19/32; B62K 19/36; B62M 7/02; B62J 23/00; B62J 35/00; B62J 40/00

(52) U.S. Cl. CPC B62K 5/01; B62K 19/32; B62K 19/36; B62J 40/00; B62J 23/00; B62J 35/00; B62M 7/02

(57) ABSTRACT

An all-terrain vehicle includes a frame, an engine, an air filter, and a fuel tank. The frame includes a seat cushion and a steering handle. The engine is arranged on the frame and provides power. The air filter is arranged on the frame and coupled to the engine. The fuel tank is arranged on the frame and coupled to the engine. The air filter at least partially shields an upper surface of the fuel tank.

### CROSS-REFERENCE TO RELATED APPLICATION

This application is based on and claims priority to Chinese Application No. 202120374068.1, filed on Feb. 10, 2021, the entire contents of which are incorporated herein by reference.

### FIELD

The present disclosure relates to the field of motor vehicles and, more particularly, to an all-terrain vehicle.

### BACKGROUND

Saddle-type all-terrain vehicles in the related art include exposed fuel tanks that are usually arranged in front of and above seats. The higher position of the fuel tanks causes the center of gravity of the vehicles to be high, easily making the vehicles unsteady. Moreover, the fuel tanks externally arranged are exposed to the sun in the open air, which is a safety risk.

### SUMMARY

An all-terrain vehicle includes: a frame including a seat cushion and a steering handle; an engine including a crankcase arranged on the frame; an air filter arranged on the frame and coupled to the engine through an engine intake pipe; and a fuel tank arranged on the frame, wherein a projection of the fuel tank at least partially overlaps with a projection of the crankcase of the engine in a plane perpendicular to a longitudinal central symmetry plane of the all-terrain vehicle.

Another all-terrain vehicle includes: a frame including a seat cushion and a steering handle; an engine including a crankcase arranged on the frame; an air filter arranged on the frame and coupled to the engine through an engine intake pipe; and a fuel tank arranged on the frame, and located between the engine and the air filter and in front of the engine and the air filter.

### BRIEF DESCRIPTION OF DRAWINGS

FIG. 1 is a perspective view of an all-terrain vehicle in an embodiment of the present disclosure.

FIG. 2 is a perspective view of an all-terrain vehicle in an embodiment of the present disclosure, with a partial structure thereof being hidden.

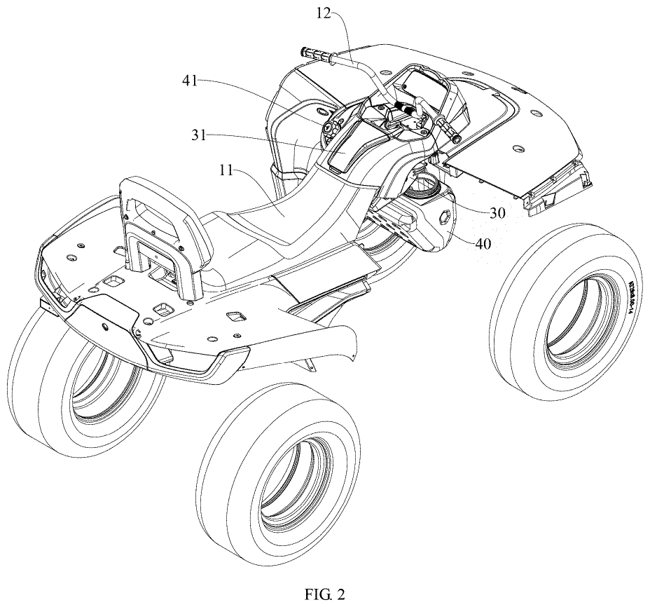

FIG. 3 is a top view of an all-terrain vehicle in an embodiment of the present disclosure.

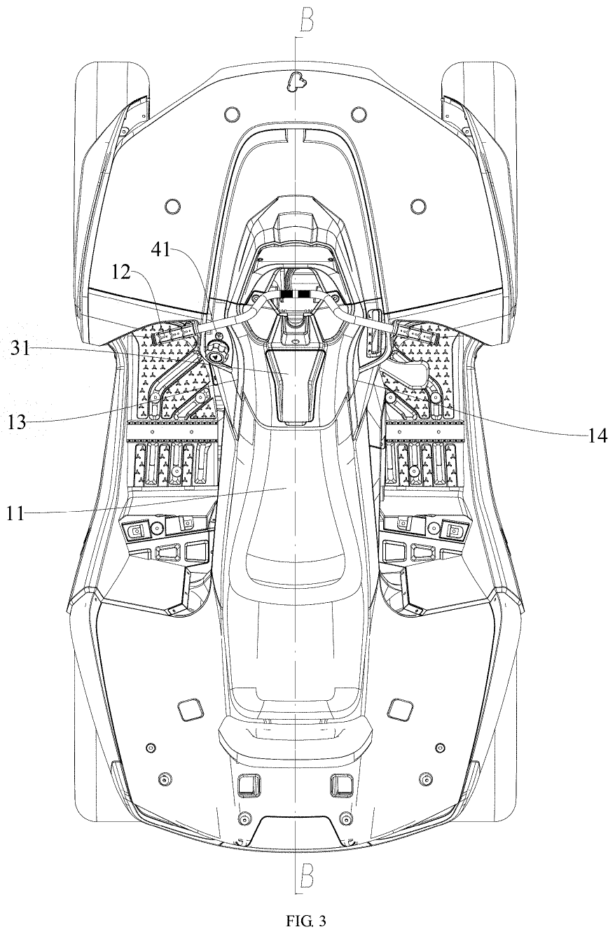

FIG. 4 is a sectional view of FIG. 3 along B-B.

FIG. 5 is a schematic view illustrating installation of a fuel tank in a first angle of view in an embodiment of the present disclosure.

FIG. 6 is a schematic view illustrating installation of a fuel tank in a second angle of view in an embodiment of the present disclosure.

### DETAILED DESCRIPTION OF EMBODIMENTS

Embodiments of the present disclosure will be described in detail below, and examples of the embodiments are shown in the accompanying drawings. The embodiments described below with reference to the accompanying drawings are exemplary and are intended to explain the present disclosure rather than limit the present disclosure.

Referring to the drawings, embodiments of the present disclosure provide an all-terrain vehicle including: a frame 10, an engine 20, an air filter 30, and a fuel tank 40. The frame 10 includes a seat cushion 11 and a steering handle 12. The engine 20 is arranged on the frame 10 and provides power, and the engine includes a crankcase arranged on the frame 10. The air filter 30 is arranged on the frame 10 and is coupled to the engine 20 through an engine intake pipe. The fuel tank 40 is arranged on the frame 10 and coupled to the engine 20. In a plane perpendicular to a longitudinal central symmetry plane of the all-terrain vehicle, a projection of the fuel tank 40 at least partially overlaps with a projection of the crankcase of the engine 20. Such an arrangement can lower a center of gravity of the fuel tank and make the vehicle more stable during driving.

The fuel tank 40 may be located in front of the engine 20. In some embodiments, the fuel tank 40 may be located in front of and above the engine 20. In other embodiments, the fuel tank 40 may be located between the engine 20 and a front wheel 60 of the all-terrain vehicle, and the center of gravity of the fuel tank 40 is above a center of the front wheel 60. Thus, the spatial arrangement of various components of the all-terrain vehicle can be optimized and the stability of the all-terrain vehicle during driving can be further improved.

In a specific embodiment, the air filter 30 is located between the seat cushion 11 and the steering handle 12, and the air filter 30 at least partially shields an upper surface of the fuel tank 40. The weight of the air filter 30 is lighter than that of the fuel tank 40, and arranging the lighter air filter 30 in a higher position is conducive to the lowering of the center of gravity of the whole vehicle. Further, since the air filter 30 at least partially shields the upper surface of the fuel tank 40, it is possible to diminish or prevent the fuel tank 40 from being exposed, reducing or avoiding exposure to the sun, and lowering the safety risk.

Further, the fuel tank 40 is located the front of and below the air filter 30, and the lowered position of the fuel tank 40 facilitates the lowering of the center of gravity of the entire vehicle and improves the stability of the entire vehicle. In some embodiments, the position of the seat cushion 11 is higher than the position of the fuel tank 40, further lowering the center of gravity of the fuel tank 40.

In a specific embodiment, the center of gravity of the fuel tank 40 is located in front of and below a center of gravity of the air filter 30. That is, the fuel tank 40 is located below and forward of the air filter 30.

A decorative cover 31 is arranged on a top of the air filter 30 and covers the air filter 30. The decorative cover 31 is smoothly transitioned to the seat cushion 11. The decorative cover 31 protects the air filter 30 and is able to cover all components below the decorative cover 31 (at least including a partial structure of the fuel tank 40) in all directions. The smooth transition described here means that adjacent edges of the two components are at the same height.

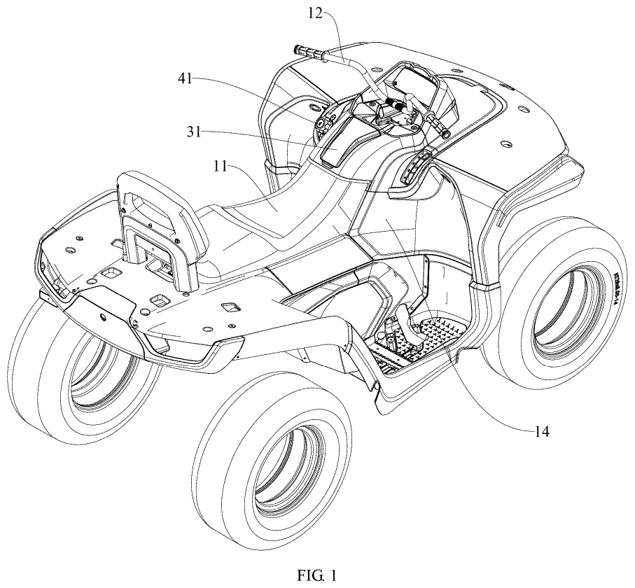

In a specific embodiment, a refueling port 41 of the fuel tank 40 is located on a left or right side of the decorative cover 31. As shown in FIG. 1, the refueling port 41 of the fuel tank 40 is located on the left side of the decorative cover 31 of the air filter.

Referring to FIG. 1, left and right sides of the decorative cover 31 extend downward; the frame 10 also includes a left shield 13 and a right shield 14 arranged on left and right sides of the fuel tank 40, respectively; and the left shield 13 and the right shield 14 are each smoothly transitioned to the decorative cover 31 of the air filter. The left shield 13 and right shield 14 can protect the fuel tank 40 on both sides of the fuel tank 40, to realize more concealed arrangement of the fuel tank 40 on the frame 10 and further prevent the fuel tank 40 from being exposed to the sun.

Further, the decorative cover 31 includes a holding space that can be selectively opened and closed. The holding space can be used to mount electrical terminals, realizing the concealed arrangement of the electrical terminals and preventing dust or rain from affecting the performance of the electrical terminals, and can also be used for storage to make it convenient for drivers to store some items.

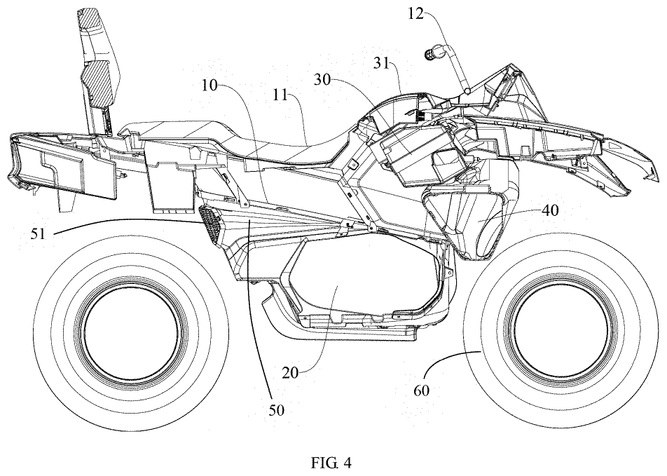

Referring to FIG. 4, a shield plate 50 is arranged above and in rear of the engine 20, and specifically, the shield plate 50 is in rear of the driver's leg when the driver is normally driving the all-terrain vehicle. The shield plate 50 has an air inlet 51 that may be a grille arranged on the shield plate 50, and air may cool an exhaust pipe through the air inlet 51 during the driving.

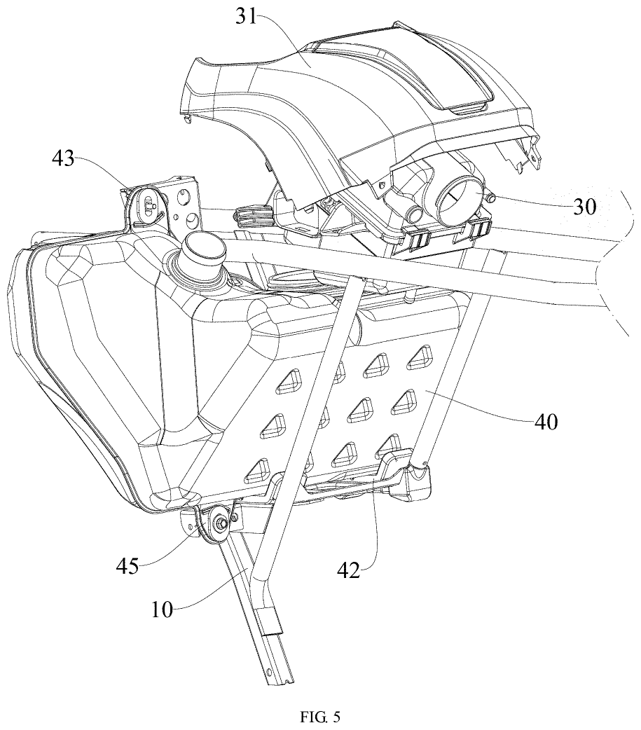

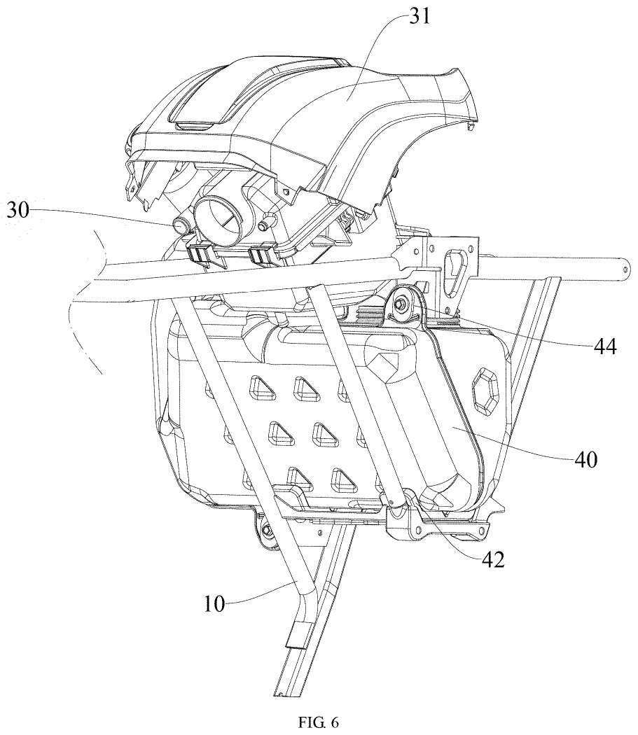

Referring to FIG. 5 and FIG. 6, a shock-absorbing rubber pad 42 is arranged on a lower surface of the fuel tank 40. The shock-absorbing rubber pad 42 is used to protect the fuel tank 40 from being touched by the vehicle frame 10. The shock-absorbing rubber pad 42 can be made of rubber to play a cushioning role.

The fuel tank 40 and the frame 10 at least have a first connection point 43, a second connection point 44, and a third connection point 45. The first connection point 43 and the second connection point 44 are located on an upper part of the fuel tank 40, and the third connection point 45 is located on a lower part of the fuel tank 40. The three connection points ensures the stable installation of the fuel tank 40.

In an embodiment, a horizontal cross-section of the fuel tank 40 decreases from top to bottom, so that a shape of the fuel tank 40 allows the fuel tank to be adaptively fitted to the frame 10. The horizontal cross-section herein refers to the horizontal cross-section of the fuel tank 40 when mounted to the frame. In some embodiments, an overall shape of the fuel tank 40 in a mounted state is approximately an inverted triangle, and the fuel tank is arranged as far forward as possible on the premise of not interfering with front wheels 60.

In conclusion, for the all-terrain vehicle provided by the embodiments of the present disclosure, based on the concealed design of the fuel tank, the mounting position of the fuel tank is lowered and thus the center of gravity of the whole vehicle is lowered, making the vehicle more stable during driving. Further, the fuel tank is no longer exposed, reducing the safety hazards arising from the fuel tank being exposed to the sun, and reducing the volatilization of gasoline due to high temperature.

In the description of the present disclosure, it is to be understood that terms such as “central,” “longitudinal,” “transverse,” “length,” “width,” “thickness,” “upper,” “lower,” “front,” “rear,” “left,” “right,” “vertical,” “horizontal,” “top,” “bottom,” “inner,” “outer” “clockwise,” “counterclockwise,” “axial,” “radial” and “circumferential” should be construed to refer to the orientation as shown in the drawings. These relative terms are for convenience and simplicity of description and do not indicate or imply that the present disclosure have a particular orientation or be constructed and operated in a particular orientation. Thus, these terms shall not be construed to limit the present disclosure.

In addition, terms such as “first” and “second” are used herein for purposes of description and are not intended to indicate or imply relative importance or significance or to imply the number of indicated technical features. Thus, the feature defined with “first” and “second” may include one or more of this feature. In the description of the present disclosure, the term “a plurality of” means at least two, such as two or three, unless specified otherwise.

In the description of the present disclosure, it should be noted that unless specified or limited otherwise, the terms “mounted,” “connected,” “coupled” and “fixed” are used broadly, and may be, for example, fixed connections, detachable connections, or integral connections; may be mechanical connection or electrical connections or communicate with each other; may be direct connections or indirect connections via intervening structures; may also be communication of two elements. The above terms can be understood by those skilled in the art according to specific situations.

In the present invention, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on.” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

In the present disclosure, reference throughout this specification to “an embodiment,” “some embodiments,” “an example,” “a specific example” or “some examples” means that a particular feature, structure, material, or characteristic described in connection with the embodiment or example is included in at least one embodiment or example of the present disclosure. In the specification, the appearances of the above terms are not necessarily referring to the same embodiment or example. Furthermore, the particular features, structures, materials, or characteristics may be combined in any suitable manner in one or more embodiments or examples. In addition, those skilled in the art may integrate and combine different embodiments or examples as well as features in different embodiments or examples in the case of no mutual conflict.

Although embodiments of the present disclosure have been shown and illustrated, it shall be understood by those skilled in the art that various changes, modifications, alternatives and variants can be made in the embodiments without departing from the principle and purpose of the present disclosure. The scope of the present disclosure is defined by the claims and their equivalents.

What is claimed is:

1. An all-terrain vehicle, comprising:
a frame comprising a seat cushion and a steering handle;
an engine comprising a crankcase arranged on the frame;
an air filter arranged on the frame and coupled to the engine through an engine intake pipe; and
a fuel tank arranged on the frame, wherein a projection of the fuel tank at least partially overlaps with a projection of the crankcase of the engine in a plane perpendicular to a longitudinal central symmetry plane of the all-terrain vehicle.

2. The all-terrain vehicle according to claim 1, wherein the air filter is located between the seat cushion and the steering handle, and the air filter at least partially shields an upper surface of the fuel tank.

3. The all-terrain vehicle according to claim 2, wherein the fuel tank is located in front of and below the air filter, and a position of the seat cushion is higher than a position of the fuel tank.

4. The all-terrain vehicle according to claim 1, wherein the fuel tank is located between a front wheel and the engine, and a center of gravity of the fuel tank is above a center of the front wheel.

5. The all-terrain vehicle according to claim 2, wherein a decorative cover is arranged on a top of the air filter and covers the air filter, and the decorative cover is smoothly transitioned to the seat cushion.

6. The all-terrain vehicle according to claim 1, further comprising a shield plate arranged above and in rear of the engine, wherein the shield plate has an air inlet, and the air inlet is a grille arranged on the shield plate and allows air to enter for cooling.

7. The all-terrain vehicle according to claim 5, wherein the decorative cover has a holding space, and the holding space is selectively openable and closable and is configured to mount electrical terminals or store items.

8. The all-terrain vehicle according to claim 1, wherein a shock-absorbing rubber pad is arranged on a lower surface of the fuel tank.

9. The all-terrain vehicle according to claim 1, wherein:
the fuel tank and the frame at least have a first connection point, a second connection point, and a third connection point; and
the first connection point and the second connection point are located on an upper part of the fuel tank, and the third connection point is located on a lower part of the fuel tank.

10. The all-terrain vehicle according to claim 1, wherein a horizontal cross-section of the fuel tank decreases from top to bottom.

11. The all-terrain vehicle according to claim 5, wherein adjacent edges of the decorative cover and the seat cushion are at a same height.

12. The all-terrain vehicle according to claim 5, wherein:
left and right sides of the decorative cover extend downward;
the frame further comprises a left shield and a right shield arranged on left and right sides of the fuel tank, respectively; and
the left shield and the right shield are each smoothly transitioned to the decorative cover.

13. The all-terrain vehicle according to claim 1, wherein the fuel tank in a mounted state has an inverted triangular cross-section.

14. An all-terrain vehicle, comprising:
a frame comprising a seat cushion and a steering handle;
an engine comprising a crankcase arranged on the frame;
an air filter arranged on the frame and coupled to the engine through an engine intake pipe; and
a fuel tank arranged on the frame, and located between the engine and the air filter and in front of the engine and the air filter.

15. The all-terrain vehicle according to claim 14, wherein the air filter is located between the seat cushion and the steering handle, and the air filter at least partially shields an upper surface of the fuel tank.

16. The all-terrain vehicle according to claim 15, wherein a decorative cover is arranged on a top of the air filter and covers the air filter, and the decorative cover is smoothly transitioned to the seat cushion.

17. The all-terrain vehicle according to claim 16, wherein a refueling port of the fuel tank is located on a left or right side of the decorative cover.

18. The all-terrain vehicle according to claim 16, wherein the decorative cover has a holding space, and the holding space is selectively openable and closable and is configured to mount electrical terminals or store items.

19. The all-terrain vehicle according to claim 14, wherein a shock-absorbing rubber pad is arranged on a lower surface of the fuel tank.

20. The all-terrain vehicle according to claim 14, wherein:
the fuel tank and the frame at least have a first connection point, a second connection point, and a third connection point; and
the first connection point and the second connection point are located on an upper part of the fuel tank, and the third connection point is located on a lower part of the fuel tank.
